(19) United States
(12) Patent Application Publication
(10) Pub. No.: US 2024/0367092 A1
(43) Pub. Date: Nov. 7, 2024

(54) Sweetener with Mixed Acetal(s) and Oxidation Inhibitor(s)

(71) Applicant: Foremark Performance Chemicals, League City, TX (US)

(72) Inventors: Jonathan R. Bingham, Mont Belvieu, TX (US); Lei Zhang, Houston, TX (US)

(73) Assignee: Foremark Performance Chemicals, League City, TX (US)

(21) Appl. No.: 18/653,493

(22) Filed: May 2, 2024

Related U.S. Application Data
(60) Provisional application No. 63/499,675, filed on May 2, 2023.

(51) Int. Cl. B01D 53/14; B01D 53/52; B01D 53/78

(52) U.S. Cl. CPC B01D 53/1468; B01D 53/1487; B01D 53/1493; B01D 53/52; B01D 53/78; B01D 2252/103; B01D 2252/2021; B01D 2252/504; B01D 2257/304; B01D 2257/306

(57) ABSTRACT

The present sweetener includes a scavenger system for removing hydrogen sulfide and/or mercaptan from a fluid gas stream and/or fluid liquid stream. The present sweetener comprises 1) 99.9 to 80 wt. % a scavenger system comprising 3 to 30% of at least one mixed acetal in at least one scavenger solvent and 2) 0.1 to 20 wt % of at least one oxidation inhibitor. The present sweetener reduced solids formation potential in the spent scavenger and/or increases performance.

### CROSS-REFERENCE TO RELATED APPLICATIONS

This application claims the benefit, under 35 U.S.C. 119(e), of U.S. Provisional Application No. 63/499,675 filed May 2, 2023, the contents of which are incorporated herein by reference.

### BACKGROUND OF THE INVENTION

Hydrogen sulfide is a toxic and corrosive component of natural gas and oil. The presence of hydrogen sulfide is undesirable and sweeteners are used to lower the concentration of hydrogen sulfide to allow commercialization of natural gas and oil.

There are many sweeteners used to remove hydrogen sulfide such as triazines, oxazolidines, hemiacetals, metal oxides, salts, and other novel scavengers. Desirable characteristics in a sweetener include: fast reaction rates, high capacity for removal of hydrogen sulfide, low or no solids formation, and a pH that does not promote scaling with minerals.

One type of scavenger is described in U.S. Pat. No. 11,247,167, as shown generally below:

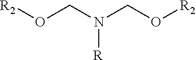

This includes a mixed acetal or hemiacetal amine complex that is fast and has a lower solids formation potential (in some cases no solids). However, the mixed acetals formed by this reaction have two main downsides.

The first downside of the scavenger in U.S. Pat. No. 11,247,167 is that in the presence of water an equilibrium with hemiacetals, the mixed acetal and a hexahydro triazine complex occurs. The downside to this equilibrium is an elevated potential of the spent forming solids and a slowed reaction rate. The elevated solids potential can be countered through use of solvents such as methanol or other solids/crystal inhibiting complexes.

The second downside of the scavenger in U.S. Pat. No. 11,247,167 is that thermally induced oxidation can occur. This oxidation has been observed with several amines and amides including: methylamine, ethylamine, monoethanolamine, and isopropylamine. It is believed that amine and amide variants see this thermally induced oxidation to different degrees. This oxidation can be the result of oxygen, or catalysts present that cause amine oxidation. Oxidation can result in increased solids formation of the spent material and/or decreased scavenging performance.

### SUMMARY OF INVENTION

The present sweetener remediates the oxidation problems seen in the prior art. The present sweetener is a better scavenger for removing hydrogen sulfide and/or mercaptans from fluid streams, such as natural gas and/or oil streams. The improved aspect includes reduced solids formation potential in the spent scavenger and/or increase performance.

The present sweetener includes: 1) a scavenger system comprising at least one mixed acetal in at least one scavenger solvent and 2) at least one oxidation inhibitor. The at least one mixed acetal is preferably formed by combining at least one amide or amine with at least one hemiacetal.

### BRIEF DESCRIPTION OF THE DRAWINGS

The features and advantages of the present invention will become apparent from the following detailed description of a preferred embodiment thereof, taken in conjunction with the accompanying drawings, in which:

FIG. 1 is a chart showing the absorption of hydrogen sulfide by increase in refractive index vs the amount of hydrogen sulfide added to the sample using the teaching of the prior art;

FIG. 2 is an FTIR showing observed amine oxidation using the teaching of the prior art; and

FIG. 3 is a graph showing the loss of performance to be greatly reduced with the present sweetener compared to samples taught in the prior art without inhibitors.

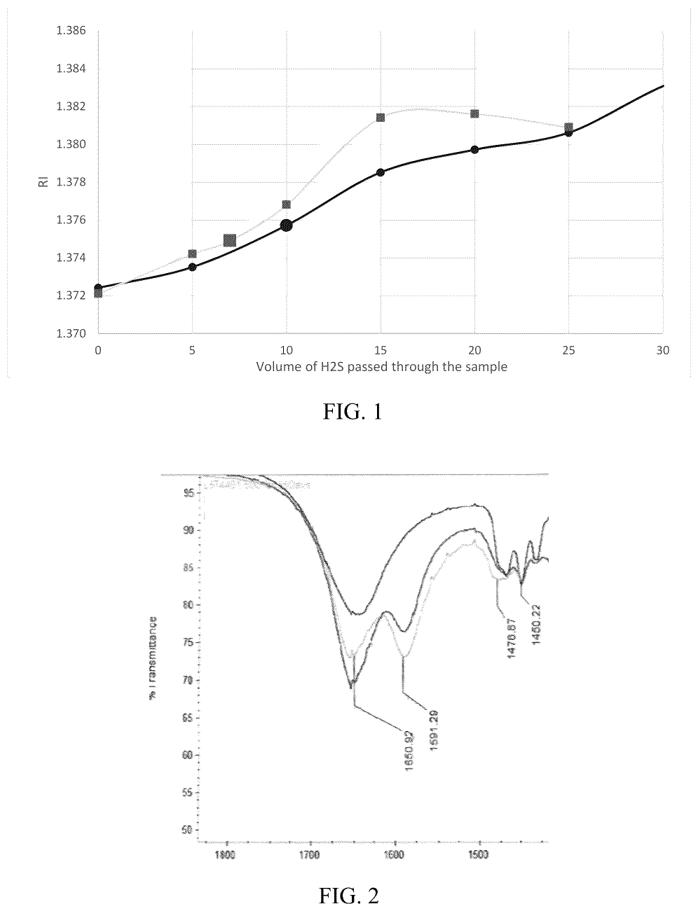

### DETAILED DESCRIPTION OF THE INVENTION

The present invention is directed to a sweetener for removing hydrogen sulfide and/or mercaptans from a fluid gas and/or fluid liquid stream comprising, 1) 99.9 to 80 wt. % a scavenger system comprising 3 to 30 wt. % of at least one mixed acetal in at least one scavenger solvent and 2) 0.1 to 20 wt % of at least one oxidation inhibitor.

In one embodiment, the sweetener for removing hydrogen sulfide and/or mercaptans from a fluid gas and/or fluid liquid stream consists essential of, 1) 99.9 to 80 wt. % a scavenger system consisting essentially of 3 to 30 wt. % of at least one mixed acetal and ≤25 wt. % other ingredients in at least one scavenger solvent; and 2) 0.1 to 20 wt % of at least one oxidation inhibitor. Alternatively, the scavenger system may include≤20 wt. % other ingredients, or ≤15 wt. % other ingredients, or ≤10 wt. % other ingredients, or ≤5 wt. % other ingredients, or ≤1 wt. % other ingredients. An essential feature of the present sweetener is the removal of hydrogen sulfide and/or mercaptans from fluid streams with reduced solids formation potential in the spent scavenger and/or increased performance.

In another embodiment, the sweetener for removing hydrogen sulfide and/or mercaptans from a fluid gas and/or fluid liquid stream consists of, 1) 99.9 to 80 wt. % a scavenger system consisting of 3 to 30 wt. % of at least one mixed acetal and ≤25 wt. % other ingredients in at least one scavenger solvent; and 2) 0.1 to 20 wt % of at least one oxidation inhibitor. Alternatively, the scavenger system may include≤20 wt. % other ingredients, or ≤15 wt. % other ingredients, or ≤10 wt. % other ingredients, or ≤5 wt. % other ingredients, or ≤1 wt. % other ingredients.

“Other ingredients” is any ingredient other than the at least one mixed acetal, at least one scavenger solvent, and at least one oxidation inhibitor that does not prevent the present sweetener from removing hydrogen sulfide and/or mercaptans from fluid streams. Such “other ingredients” may include other sweetener(s) selected from the group consisting of hemiacetals, triazines, oxazoladines, and/or other mixed acetals.

The scavenger system includes at least one mixed acetal of Compound 1

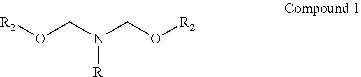

wherein R is selected from the group consisting of methyl, ethyl, ethyl alcohol, propyl, methoxypropyl, isopropyl, butyl, iso butyl, t-butyl, and combinations thereof and R₂ is selected from the group consisting of methyl, ethyl, propyl, isopropyl, methoxy propyl, butyl, ethyl alcohol, propyl alcohol, butoxyethanol, and combinations thereof. In a preferred embodiment, R₂ is any six carbon chain including ethers, esters, alcohols, ketones, aldehydes, or combinations thereof.

In one embodiment of the present invention, the at least one mixed acetal includes an N-glycosidic type bond as taught in U.S. Pat. No. 11,247,167, the contents of which are expressly incorporated herein by reference. In a preferred embodiment of the present invention, a hemiacetal is formed as a product of formaldehyde, glutaraldehyde or glyoxal and at least one common alcohol. The common alcohol is preferably selected from the group consisting of methanol, propyl alcohols, ethanol, ethylene glycol, butyl alcohols, butoxyethanol and combinations thereof. In a preferred embodiment, the hemiacetal is then combined with an amine or amide to add nitrogen to form the at least one mixed acetal. In a preferred embodiment of the present invention, the amide may be selected from the group consisting of formamide, acetamide, propylamides, butylamides, urea, and combinations thereof. In a preferred embodiment of the present invention, the amines may be selected from the group consisting of methylamine, ethylamine, ethanolamine, propylamines, butylamines, isopropyl amine, butyl amine, iso butyl amine, t-butylamine, and combinations thereof.

In a preferred embodiment of the present invention, the oxidation inhibitor is selected from the group consisting of sodium sulfite, ethylenediamine, EDTA, diaminocyclohexane, formate, piperazine, 2-methyl-piperazine, methyl-diethanolamine, potassium iodide, and combinations thereof. Furthermore, the oxidation inhibitor may be oligomers, polymers, or reaction products made using a compound selected from the group consisting sodium sulfite, aminoacids, ethylenediamine, EDTA, diaminocyclohexane, formate, piperazine, 2-methyl-piperazine, methyl-diethanolamine, potassium iodide, and combinations thereof. In a preferred embodiment, the oxidation inhibitor is a polymer made from diamino cyclohexane.

The at least one scavenger solvent is selected from the group consisting of water, methanol, ethanol, isopropanol, propanol, glycol, diethylether, dimethylformamide, acetone, butylalcohol, secbutyl alcohol, tertbutyl alcohol, hexanes, and mixtures thereof. In a preferred embodiment, the scavenger solvent is water, methanol, or mixtures thereof. In a preferred embodiment the scavenger solvent is a mixture of methanol and water at a ratio of 50:50-80:20 methanol to water based on the total weight of the sweetener.

It is understood that all ranges inherently include all numbers lying within the upper and lower limits. For example, 99.9 to 80 wt. % a scavenger system includes upper and/or lower limits selected from 99.1, 99.5, 99, 98, 97, 96, 95, 94, 93, 92, 91, 90, 89, 88, 87, 86, 85, 84, 83, 82, 81, and 80 wt. %. In addition to the above, for example, 3 to 30 wt. % of at least one mixed acetal includes upper and/or lower limits selected from 3, 4, 5, 6, 7, 8, 9, 10, 11, 12, 13, 14, 15, 16, 17, 18, 19, 20, 21, 22, 23, 24, 25, 26, 27, 28, 29, and 30 wt. %. In addition to the above, for example, 0.1 to 20 wt. % of at least one oxidation inhibitor includes upper and/or lower limits selected from 0.1, 0.5, 1, 2, 3, 4, 5, 6, 7, 8, 9, 10, 11, 12, 13, 14, 15, 16, 17, 18, 19, and 20 wt. %.

The present sweetener may be provided as a sweetener solvent system to a fluid gas and/or fluid liquid stream. Preferably, the fluid gas and/or fluid liquid stream from which the hydrogen sulfide and/or mercaptan is removed is a natural gas and/or oil stream. The sweetener solvent system may include, but is not limited to, water or methanol and water. As such, the sweetener may be provided as an aqueous sweetener solvent system. The definition is not intended to exclude the inclusion of other solvents, for example, alcohols, or other additives from the solvent system. Typically, the sweetener solvent system is a solution that may contain from 90-20 wt. % water, or 60-40 wt. % water. The range of 90-20 wt. % water includes, for example, upper and/or lower limits selected from 90, 85, 80, 75, 70, 65, 60, 55, 50, 45, 40, 35, 30, 25, and 20 wt. %. Furthermore, in addition to water, the sweetener solvent system may contain from 20-50 wt. % methanol. The range of 20-50 wt. % methanol includes, for example, upper and/or lower limits selected from 20, 25, 30, 35, 40, 45, and 50 wt. %.

The present invention is further directed to a method for reducing the concentration of hydrogen sulfide, mercaptans, and mixtures thereof from a fluid gas stream and/or fluid liquid stream comprising the step of contacting the fluid gas stream and/or fluid liquid stream with the present sweetener. In a preferred embodiment, the present sweetener is added directly to the fluid gas and/or fluid liquid stream, typically via direct injection or tower.

The present sweetener is ideally suited for removing hydrogen sulfide and/or mercaptans under both concentrated and dilute conditions. In one embodiment, the dilute conditions include fluid gas streams having ≤10 wt. % hydrogen sulfide. In one embodiment, the dilute conditions include fluid gas streams having ≤5 wt. % hydrogen sulfide. In another embodiment, the dilute conditions include fluid gas streams having ≤2 wt. % hydrogen sulfide.

Generally, the overall formula of mercaptans is R—SH, wherein R is a hydrocarbon chain. Example of mercaptans include, but are not limited to, methanethiol—CH₃SH [methyl mercaptan], ethanethiol-C₂H₅SH [ethyl mercaptan], 1-propanethiol—C₃H₇SH [n-propyl mercaptan], 2-propanethiol—CH₃CH(SH)CH₃ [2C₃ mercaptan], allyl mercaptan CH₂═CHCH₂SH [2-propenethiol], butanethiol—C₄H₉SH [n-butyl mercaptan], tert-butyl mercaptan —(CH₃)₃CSH [t-butyl mercaptan], pentanethiols C₅H₁₁SH [pentyl mercaptan], etc . . .

In a preferred embodiment, the sweetener reduces the concentration of hydrogen sulfide and/or mercaptans in a fluid gas stream by at least 20 wt. %, preferably by at least 25 wt. %, more preferably by at least 28 wt. %. In yet another embodiment of the present invention, the sweetener reduces the concentration of hydrogen sulfide and/or mercaptans in a fluid gas stream by at least 20 wt. %, preferably by at least 25 wt. %, more preferably by at least 28 wt. % when the fluid gas stream includes≤10 wt. %, or ≤5 wt. %, or ≤3 wt. % of hydrogen sulfide prior to contact with the sweetener.

It was discovered that the prior art is especially vulnerable to amine oxidation when compared to traditional scavengers such as MEA triazine. While performance loss is minimal (≤5%) for a sample of MEA triazine stored at 80° C. for a week, a mixed acetal as provided in U.S. Pat. No. 11,247,167 where R=—CH₃ and R₂=—CH₃ shows performance drops up to 50% and/or increased solids formation of the spent material. Solids formation in the oxidized scavengers also increased significantly. In many cases solids formation rates doubled compared to samples treated with inhibitors.

FIG. 11 shows the absorption of hydrogen sulfide by increase in refractive index vs the amount of hydrogen sulfide added to the sample using a mixed acetal as taught in U.S. Patent 11, 247,167 where R=—CH₃ and R₂=—CH₃. The sweetener included 7-12 wt. % mixed acetal with the remainder being 50:50 methanol and water mix (based on weight). The light gray line (▪) shows a sample that was stored at 80° C. for one week. The dark gray line (●) shows the sample stored at room temperature. The sample stored at 80° C. has a cloud point of 7 and it stops uptaking hydrogen sulfide at volume of 15. The sample stored at room temperature has cloud point of 15 and keeps uptaking hydrogen sulfide at a volume of 30. Cloud point is related to solids formation, the lower the cloud point the more likely the scavenger to form solids. Also of note is the RI does not go as high in the 80° C. sample as the room temperature sample, this indicates less absorption of hydrogen sulfide.

Amine oxidation using a mixed acetal as taught in US Patent 11, 247,167 where R=—CH₃ and R₂=—CH₃ is observed in the FTIR shown in FIG. 2. The normal amine peak is at 1650 cm⁻¹. The amine oxide formation is evident by the peak showing up at 1580 cm⁻¹.

Amine oxidation occurs more rapidly the larger the molecule: for example ethylamine is more easily oxidized than methylamine as evidenced by color formation at elevated temperatures.

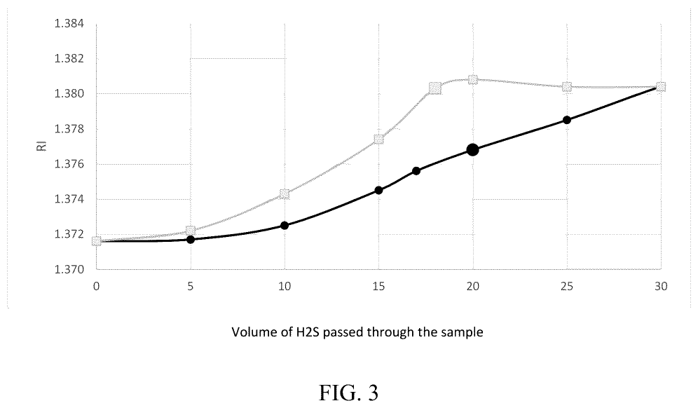

In one embodiment, the present sweetener includes 2 wt. % a polymer made from diamino cyclohexane as the oxidation inhibitor (see Example 2 below) with 7-12 wt. % mixed acetal of Compound 1 where R=—CH₃ and R₂=—CH₃ with the remainder being being 50:50 methanol and water mix (based on weight). The products become more thermally stable for samples stored at 80° C. for a week compared to the chemistry from U.S. Pat. No. 11,247,167 where R=—CH₃ and R₂=—CH₃ discussed above without the oxidation inhibitor. FIG. 3 shows the loss of performance using the present invention to be greatly reduced compared to samples without oxidative inhibitors. The reduced oxidation is also evident by the color of the samples.

Samples with oxidative inhibitors had no visible color formation to reduced color formation.

FIG. 3 shows the absorption of hydrogen sulfide by increase in refractive index vs the amount of hydrogen sulfide added to the sample. The light gray line (▪) shows an inhibited sample that was stored at 80° C. for one week. The dark gray line (●) shows the same inhibited sample stored at room temperature. The sample stored at 80° C. has a cloud point of 18 and it stops uptaking hydrogen sulfide at volume of 20. The sample stored at room temperature has cloud point of 20 and keeps uptaking hydrogen sulfide at a volume of 30. Cloud point is related to solids formation, the lower the cloud point the more likely the scavenger to form solids. Also of note is the RI change is just as much in the 80° C. sample as the room temperature sample, this indicates similar absorption of hydrogen sulfide. In this case the performance of the two scavengers is comparable, with the heated sample absorbing hydrogen sulfide quicker.

### EXAMPLES

The foregoing may be better understood by reference to the following examples, which is presented for purposes of illustration and is not intended to limit the scope of the invention.

### Example 1

1.2 moles of methanol is combined with 1 mole of formaldehyde solution to form a hemiacetal mixture in water. 1 mole of methylamine is slowly added to the hemiacetal mixture to form a mixed acetal. The sample is cooled to room temperature and 2.0 wt. % potassium iodide (oxidation inhibitor) is added to the mixture.

After heating the sample at 80° C. for one week, thermal degradation is less than 10% compared to 50% for the control with no oxidation inhibitor.

### Example 2

2.3 moles of methanol is combined with 2 moles of formaldehyde solution to form a hemiacetal mixture in water. 1 mole of ethylamine is added to the hemiacetal mixture to form a mixed acetal. The sample is cooled to room temperature and 2 wt. % of a diamino cyclohexane based oligomer (oxidation inhibitor) is added to the mixture.

The oligomer is made by adding one part of diamino cyclohexane to 3 parts of isopropylamine in water. The amine is then slow added to 5 parts of 52 wt. % formaldehyde solution. This creates the oxidation inhibitor.

After storing a portion of the sample at 80° C. for one week thermal degradation is 15% compared to 40% for the control with no oxidation inhibitor.

Although the present invention has been disclosed in terms of a preferred embodiment, it will be understood that numerous additional modifications and variations could be made thereto without departing from the scope of the invention as defined by the following claims:

1. A sweetener for removing hydrogen sulfide and/or mercaptans from a fluid gas stream and/or fluid liquid stream comprising:
a) 99.9 to 80 wt. % a scavenger system comprising 3 to 30 wt. % of at least one mixed acetal of Compound 1 in at least one scavenger solvent 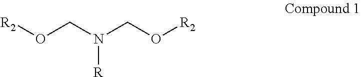
wherein R is selected from the group consisting of methyl, ethyl, ethyl alcohol, propyl, methoxypropyl, isopropyl, butyl, iso butyl, t-butyl, and combinations thereof and
R₂ is selected from the group consisting of methyl, ethyl, propyl, isopropyl, methoxy propyl, butyl, ethyl alcohol, propyl alcohol, and combinations thereof, and b) 0.1 to 20 wt. % of at least one oxidation inhibitor.

2. The sweetener of claim 1, wherein said oxidation inhibitor is selected from the group consisting of sodium sulfite, ethylenediamine, EDTA, diaminocyclohexane, formate, piperazine, 2-methyl-piperazine, methyl-diethanolamine, potassium iodide, amino acid and combinations thereof.

3. The sweetener of claim 1, wherein said oxidation inhibitor is made from oligomers, polymers, or reaction products made using a compound selected from the group consisting of sodium sulfite, ethylenediamine, EDTA, potassium iodide, diaminocyclohexane, formate, piperazine, 2-methyl-piperazine, methyl-diethanolamine, amino acids and combinations thereof.

4. The sweetener of claim 1 wherein R₂ is any six carbon chain including ethers, esters, alcohols, ketones, aldehydes, or combinations thereof.

5. The sweetener of claim 1 wherein said at least one scavenger solvent is selected from the group consisting of water, methanol, ethanol, isopropanol, propanol, glycol, diethylether, dimethylformamide, acetone, butylalcohol, butoxyethanol, secbutyl alcohol, tertbutyl alcohol, hexanes, and mixtures thereof.

6. The sweetener of claim 1, wherein said at least one scavenger is water such that said sweetener comprisesing 90-20 wt. % water based on the total weight of the sweetener.

7. The sweetener of claim 1 wherein said at least one scavenger solvent is water such that said sweetener comprieses 60-40 wt. % water based on the total weight of the sweetener.

8. The sweetener of claim 1, wherein said at least one scavenger solvent consists of a mixture of water and methanol.

9. The sweetener of claim 8 wherein said at least one scavenger solvent is a mixture of water and methanol such that said sweetener comprises 50:50-80:20 methanol to water based on the total weight of the sweetener

10. The sweetener of claim 8 wherein said at least one scavenger solvent is a mixture of water and methanol such that said sweetener comprises 80:20 methanol to water based on the total weight of the sweetener

11. The sweetener of claim 1 including at least one other sweetener.

12. The sweetener of claim 11 wherein said at least one other sweetener is selected from the group consisting of hemiacetals, triazines, oxazoladines, other mixed acetals, and mixtures thereof.

13. A method for reducing the concentration of hydrogen sulfide, mercaptans, and mixtures thereof from a fluid gas stream and/or fluid liquid stream comprising the step of contacting the fluid gas stream and/or fluid liquid stream with the sweetener of claim 1.

14. The method of claim 13, wherein said fluid gas stream is a natural gas stream.

15. The method of claim 13, wherein said fluid liquid stream is an oil stream.

16. The method of claim 13, wherein the sweetener is injected into the fluid gas stream and/or fluid liquid stream.

17. The method of claim 13, wherein the sweetener is contact the the fluid gas stream and/or fluid liquid stream via a tower.
